(19) United States
(12) Patent Application Publication
(10) Pub. No.: US 2025/0242587 A1
(43) Pub. Date: Jul. 31, 2025

(54) LIQUID EJECTION HEAD AND PRINTER

(71) Applicant: BROTHER KOGYO KABUSHIKI KAISHA, Nagoya (JP)

(72) Inventor: Rie JOBOJI, Nagoya (JP)

(21) Appl. No.: 18/974,886

(22) Filed: Dec. 10, 2024

(30) Foreign Application Priority Data
Jan. 31, 2024 (JP) 2024-013385

(51) Int. Cl. B41J 2/14

(52) U.S. Cl. CPC B41J 2/14; B41J 2002/14491; B41J 2202/08

(57) ABSTRACT

A liquid ejection head includes a channel member, an actuator member, a wiring member, and a spring. The channel member has a liquid channel including a nozzle. The actuator member is disposed on an upper surface of the channel member. The actuator member has an upper surface on which a first contact is disposed. The actuator member is configured to cause the nozzle to eject liquid. The wiring member includes a connection portion and a folded portion. The connection portion is disposed on the upper surface of the actuator member. The connection portion includes a second contact electrically connected to the first contact. The folded portion is folded upward from an end of the connection portion. The spring is disposed above the connection portion. The spring includes a first urging portion configured to urge the connection portion toward the actuator member.

### REFERENCE TO RELATED APPLICATIONS

This application claims priority from Japanese Patent Application No. 2024-013385 filed on Jan. 31, 2024. The entire content of the priority application is incorporated herein by reference.

### BACKGROUND ART

A liquid ejection head that ejects liquid from a nozzle is known.

### SUMMARY

A COF (Chip on Film, an example of wiring member) includes a connection portion that is disposed on an upper surface of an actuator (an example of actuator member) and is connected to a contact (first contact) on the upper surface of the actuator, and a folded portion that is folded upward from the upper surface of the actuator. A driving IC is disposed on an upper surface of the folded portion, and a heat dissipation member is disposed at an upper side of the driving IC. The driving IC is urged toward the heat dissipation member by an urging member. Thus, heat generated in the driving IC is released to the heat dissipation member.

In the above configuration, the driving IC is urged toward the heat dissipation member for the purpose of releasing the heat of the driving IC. However, in the configuration in which the wiring member includes the connection portion and the folded portion as described above, not only releasing the heat of the driving IC, but also the following problem may occur.

For example, when the folded portion hangs down, the radius of the boundary between the connection portion and the folded portion increases, a force in a direction away from the actuator member is applied to the vicinity of the boundary of the connection portion, and a second contact of the connection portion may be separated from a first contact of the actuator member. Further, for example, in a case where a sealant for blocking a space between the connection portion and the actuator member from an external space is disposed along an end portion of the connection portion, when the amount of the sealant is not uniform between one end and the other end of the connection portion, the curing shrinkage speed of the sealant differs, and a rotation moment is applied to the wiring member. As a result, the connection portion is disposed obliquely with respect to the upper surface of the actuator member, and the second contact of the connection portion may be separated from the first contact of the actuator member. In this way, a problem may occur that the wiring member is separated from the actuator member.

In view of the foregoing, an example of an object of this disclosure is to provide a liquid ejection head in which a wiring member is less likely to be separated from an actuator member.

According to one aspect, this specification discloses a liquid ejection head. The liquid ejection head includes a channel member, an actuator member, a wiring member, and a spring. The channel member has a liquid channel including a nozzle. The actuator member is disposed on an upper surface of the channel member. The actuator member has an upper surface on which a first contact is disposed. The actuator member is configured to cause the nozzle to eject liquid. The wiring member includes a connection portion and a folded portion. The connection portion is disposed on the upper surface of the actuator member. The connection portion includes a second contact electrically connected to the first contact. The folded portion is folded upward from an end of the connection portion. The spring is disposed above the connection portion. The spring includes a first urging portion configured to urge the connection portion toward the actuator member. Thus, the connection portion is urged toward the actuator member. According to another aspect, this specification also discloses a printer including the above-described liquid ejection head.

According to the present disclosure, the connection portion is urged (pressed) toward the actuator member by the first urging portion of the spring. Thus, the wiring member is less likely to be separated from the actuator member.

### BRIEF DESCRIPTION OF DRAWINGS

FIG. 1 is a plan view of a printer 100.

FIG. 2 is a cross-sectional view of a head 10 included in the printer 100.

FIG. 3 is a perspective view of the head 10.

FIG. 4 is a plan view of the head 10.

FIG. 5 is a cross-sectional view of the head 10 taken along a line V-V in FIG. 4.

FIG. 6 is an enlarged view of a region VI shown in FIG. 5.

FIG. 7 is a perspective view of a leaf spring 16 shown in FIGS. 3 to 6.

### DESCRIPTION

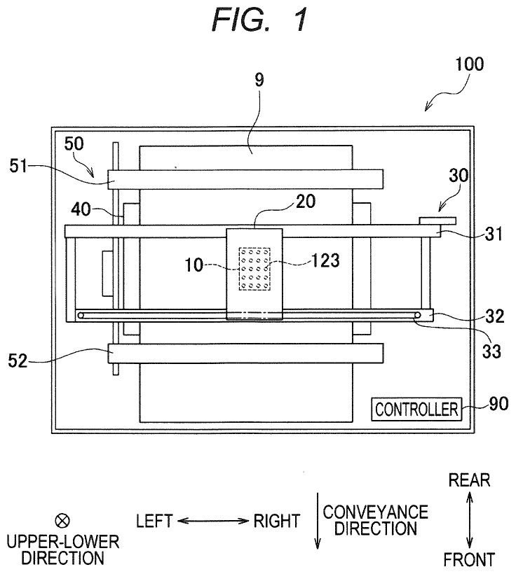

A printer 100 shown in FIG. 1 includes a head 10 which is an embodiment of “liquid ejection head” according to the present disclosure. In the following description, an upper-lower direction is defined based on a state where the printer 100 is installed to be usable, a front-rear direction is defined with a downstream side in a conveyance direction of a sheet 9 as a front side, and a left-right direction is defined when viewed from the front side of the printer 100.

The printer 100 includes the head 10, a carriage 20 that holds the head 10, a scanning mechanism 30 that moves the carriage 20 and the head 10 in the left-right direction, a platen 40 that supports the sheet 9 from below, a conveyance mechanism (conveyor) 50 that conveys the sheet 9 forward, and a controller 90.

The scanning mechanism 30 includes a pair of guides 31 and 32 that support the carriage 20, and a belt 33 that is connected to the carriage 20. The guides 31, 32 and the belt 33 extend in the left-right direction. When a carriage motor (not shown) is driven under the control of the controller 90, the belt 33 runs, and the carriage 20 and the head 10 move in the left-right direction along the guides 31 and 32.

The platen 40 is disposed below the carriage 20 and the head 10. The sheet 9 is supported on an upper surface of the platen 40.

The conveyance mechanism 50 includes a roller 51 disposed rearward of the head 10 and a roller 52 disposed forward of the head 10. The head 10, the carriage 20, and the platen 40 are disposed between the roller 51 and the roller 52 in the front-rear direction.

Each of the rollers 51 and 52 includes a set of rotating members. The set of rotating members includes an upper rotating member disposed above a conveyance path of the sheet 9 and a lower rotating member disposed below the conveyance path of the sheet 9. The upper rotating member and the lower rotating member are arranged such that their circumferential surfaces are in contact with each other.

When the conveyance motor is driven under the control of the controller 90, the respective rotating members of the rollers 51 and 52 rotate. The respective rotating members of the rollers 51 and 52 rotate while sandwiching the sheet 9 therebetween, thereby conveying the sheet 9 forward.

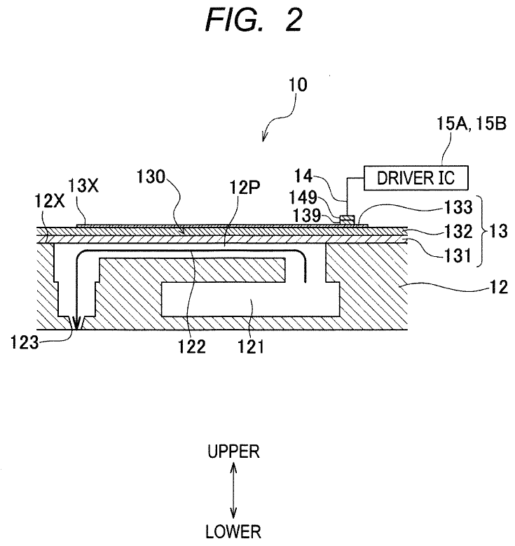

As shown in FIG. 2, the head 10 includes a channel member 12 and an actuator member 13.

A plurality of nozzles 123 are opened in the lower surface of the channel member 12. A common channel 121 communicating with an ink tank and individual channels 122 provided for respective ones of the plurality of nozzles 123 are formed inside the channel member 12. The individual channel 122 is a channel (flow path) from the outlet of the common channel 121 to the nozzle 123 via a pressure chamber 12P. A plurality of pressure chambers 12P are opened in an upper surface 12X of the channel member 12. The common channel 121 and the individual channels 122 are examples of “liquid channel” of the present disclosure.

The actuator member 13 is arranged on the upper surface 12X of the channel member 12. The actuator member 13 includes a metal vibration plate 131, a piezoelectric layer 132, and a plurality of individual electrodes 133. The vibration plate 131 is disposed on the upper surface 12X of the channel member 12 so as to cover the plurality of pressure chambers 12P. The piezoelectric layer 132 is disposed on the upper surface of the vibration plate 131. The plurality of individual electrodes 133 are disposed on the upper surface of the piezoelectric layer 132 so as to face respective ones of the plurality of pressure chambers 12P.

The vibration plate 131 and the plurality of individual electrodes 133 are electrically connected to driver ICs 15A and 15B via a COF (Chip on Film) 14. The driver ICs 15A and 15B are electrically connected to the controller 90. The COF 14 is an example of “wiring member” of the present disclosure. The driver ICs 15A and 15B are examples of “driver circuit” of the present disclosure.

On an upper surface 13X of the actuator member 13, contacts (not shown) which are disposed on the upper surface of the piezoelectric layer 132 and electrically connected to the vibration plate 131, and contacts 139 which are disposed on the upper surface 13X of the individual electrode 133 are disposed. The COF 14 includes contacts 149 which are electrically connected to the contacts disposed on the upper surface 13X, and signal lines which electrically connect the contacts 149 and the driver ICs 15A, 15B. The contact 139 is an example of “first contact” of the present disclosure. The contact 149 is an example of “second contact” of the present disclosure.

The driver ICs 15A and 15B change the potential of the individual electrode 133 while maintaining the potential of the vibration plate 131 at the ground potential under the control of the controller 90. As a result, the potential of the individual electrode 133 changes between a particular driving potential and the ground potential. At this time, an actuator 130, which is a portion of the vibration plate 131 and the piezoelectric layer 132 sandwiched between each individual electrode 133 and the corresponding pressure chamber 12P, is deformed, and thus the volume of the pressure chamber 12P is changed, and ink in the pressure chamber 12P is pressurized, and ink is ejected from the nozzle 123. The ink ejected from the nozzle 123 is ink having a volatile component, such as UV ink.

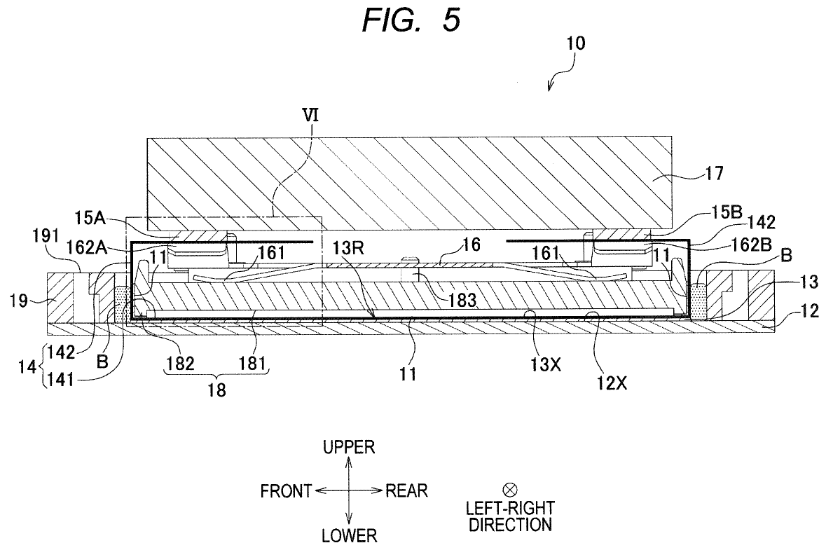

As shown in FIG. 5, the COF 14 includes a connection portion 141 disposed on the upper surface 13X of the actuator member 13, and two folded portions 142 folded upward from both ends of the connection portion 141 in the front-rear direction.

The connection portion 141 extends along the front-rear direction and the left-right direction in parallel with the upper surface 13X. A plurality of contacts 149 (see FIG. 2) are disposed on the lower surface of the connection portion 141.

Each of the two folded portions 142 includes a vertical portion extending upward from the end of the connection portion 141, and a horizontal portion extending forward or rearward from an upper end of the vertical portion toward a center of the head 10 in the front-rear direction. The driver IC 15A is disposed on the upper surface of the horizontal portion of the front folded portion 142 among the two folded portions 142, and the driver IC 15B is disposed on the upper surface of the horizontal portion of the rear folded portion 142.

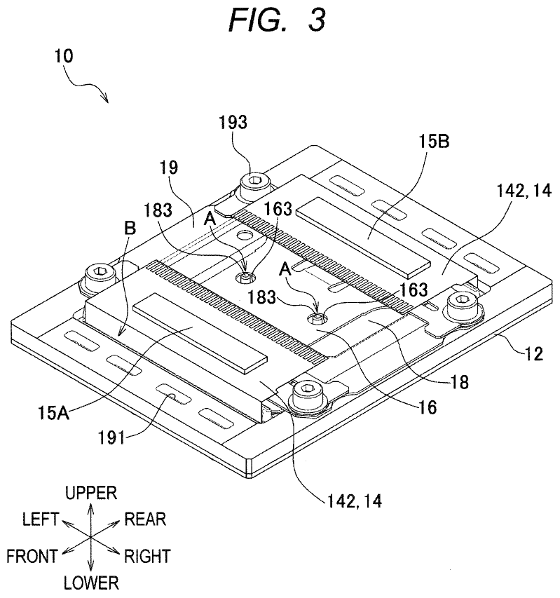

A frame 19 is disposed around the actuator member 13 on the upper surface 12X of the channel member 12. The frame 19 is a rectangular frame-shaped member disposed along the peripheral edge of the upper surface 12X. As shown in FIG. 3, four openings 191 are formed in each of the front and rear ends of the frame 19. Each opening 191 communicates with the common channel 121 of the channel member 12 and communicates with the ink tank via a tube. For example, the ink in the ink tank flows into the common channel 121 via the tube and the four openings 191 on the front side, and returns to the ink tank via the four openings 191 on the rear side and the tube.

As shown in FIG. 5, the actuator member 13 and the COF 14 are arranged within the frame 19. A pressing member 18 and a leaf spring 16 are arranged in a space surrounded by the connection portion 141 and the two folded portions 142 of the COF 14. The leaf spring 16 is an example of “spring (urging member)” of the present disclosure.

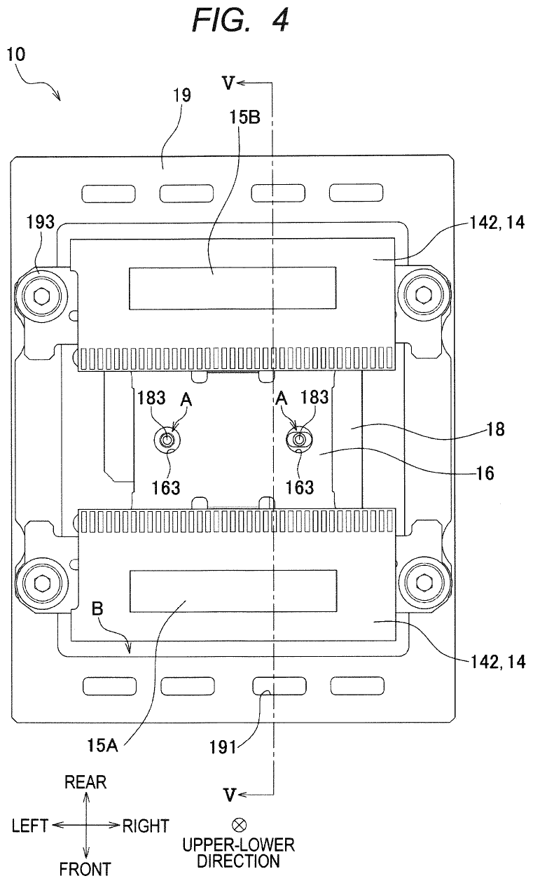

As shown in FIGS. 3 and 4, the channel member 12 and the frame 19 have a rectangular shape elongated in the front-rear direction in a plane perpendicular to the upper-lower direction. The actuator member 13 and the pressing member (pressing plate or pressing frame) 18 also have a rectangular shape elongated in the front-rear direction on a plane perpendicular to the upper-lower direction.

As shown in FIG. 5, the pressing member 18 is disposed between the connection portion 141 and the leaf spring 16, above the connection portion 141, and below the leaf spring 16.

An adhesive tape 11 is disposed on the lower surface and the side surface of the pressing member 18. The adhesive tape 11 is disposed between the pressing member 18 and the COF 14, and fixes the pressing member 18 and the COF 14 to each other. The adhesive tape 11 is arranged over the outer peripheral part of the connection portion 141 and the folded portion 142 of the COF 14. The adhesive tape 11 is an example of “adhesive member” of the present disclosure.

The volatile component in the ink reacts with the adhesive tape 11 and reduces the viscosity of the adhesive tape 11.

The lower surface of the pressing member 18 has a recess 181 and an outer peripheral portion 182. The outer peripheral portion 182 is provided at the front end, the rear end, the left end, and the right end of the pressing member 18, and surrounds the recess 181. The recess 181 overlaps (faces) with a contact region 13R on the upper surface 13X of the actuator member 13 in the upper-lower direction. A plurality of contacts 139 (see FIG. 2) are disposed in the contact region 13R. The upper-lower direction is an example of “perpendicular direction” of the present disclosure.

At the lower surface of the pressing member 18, the outer peripheral portion 182 contacts the connection portion 141 via the adhesive tape 11, while a portion where the recess 181 is formed is separated from the connection portion 141.

The upper surface of the pressing member 18 has two protrusions 183 (see FIGS. 3 and 4). Each of the two protrusions 183 protrudes upward. The direction in which the protrusion 183 protrudes is a direction from the connection portion 141 toward the leaf spring 16. The leaf spring 16 has two through holes 163 into which the two protrusions 183 are inserted in the upper-lower direction.

As shown in FIG. 5, the leaf spring 16 is disposed above the pressing member 18 and above the connection portion 141. The driver ICs 15A and 15B are disposed above the leaf spring 16, and a heat dissipation member (heat sink) 17 is disposed above the driver ICs 15A and 15B. The heat dissipation member 17 is disposed on the upper surfaces of the two driver ICs 15A and 15B. The heat dissipation member 17 is made of a material having high heat conductivity, such as metal, and has a function of dissipating heat from the driver ICs 15A and 15B. A water-cooled or air-cooled cooling member may be provided to contact the heat dissipation member 17.

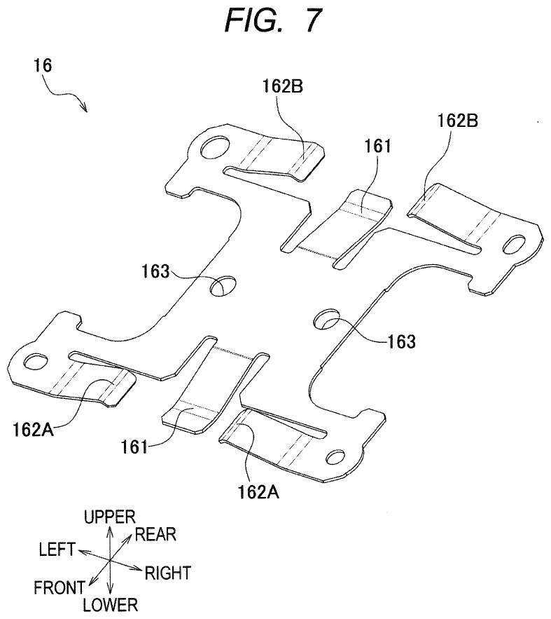

As shown in FIG. 7, the leaf spring 16 includes two first urging portions 161, two second urging portions 162A, and two second urging portions 162B in addition to the two through holes 163 described above.

The two through holes 163 are arranged in the left-right direction at the center of the leaf spring 16 in the front-rear direction. The two through holes 163 are circular and have the same diameter. As shown in FIG. 3, the two protrusions 183 are cylindrical and have the same diameter. The diameter of the through hole 163 is larger than the diameter of the protrusion 183. Each of the two through holes 163 is larger in size than each of the two protrusions 183 in any direction perpendicular to the upper-lower direction.

As shown in FIG. 3, adhesive A is disposed in the two through holes 163. The adhesive A closes the two through holes 163 into which the two protrusions 183 are inserted, respectively, and bonds the leaf spring 16 and the pressing member 18 to each other. The adhesive A may be, for example, an ultraviolet curable adhesive.

As shown in FIGS. 3 and 4, the leaf spring 16 is further fixed to the channel member 12 and the frame 19 by inserting screws 193 into through holes formed at four corners as shown in FIG. 7.

As shown in FIG. 7, the two first urging portions 161 are arranged in the front-rear direction at the center of the leaf spring 16 in the left-right direction. The two first urging portions 161 are formed of spring pieces extending forward and rearward from the central portion (body portion) of the leaf spring 16. Each first urging portion 161 is formed by bending the leaf spring 16 downward, that is, toward the actuator member 13.

As shown in FIG. 7, the two second urging portions 162A are arranged in the left-right direction at the front end of the leaf spring 16. One of the two second urging portions 162A is formed by a spring piece extending rightward from the left end of the leaf spring 16, and the other is formed by a spring piece extending leftward from the right end of the leaf spring 16. Each second urging portion 162A is formed by bending the leaf spring 16 upward, that is, toward the driver IC 15A.

As shown in FIG. 7, the two second urging portions 162B are arranged in the left-right direction at the rear end of the leaf spring 16. One of the two second urging portions 162B is formed by a spring piece extending rightward from the left end of the leaf spring 16, and the other is formed by a spring piece extending leftward from the right end of the leaf spring 16. Each second urging portion 162B is formed by bending the leaf spring 16 upward, that is, toward the driver IC 15B.

In the left-right direction, one first urging portion 161 is disposed between the two second urging portions 162A, and the other first urging portion 161 is disposed between the two second urging portions 162B.

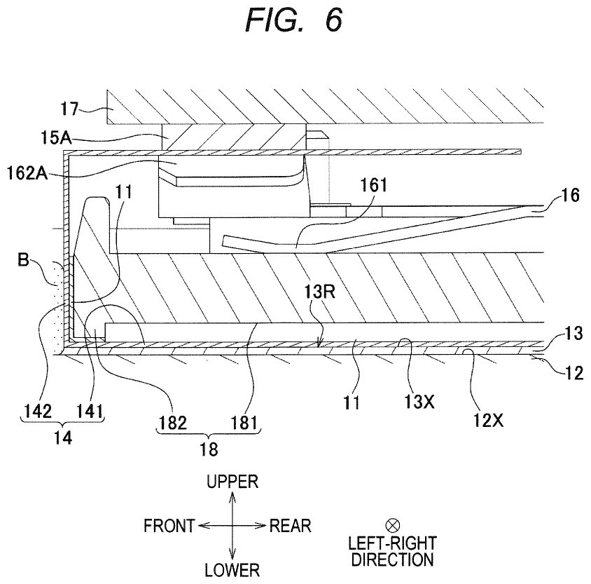

As shown in FIGS. 5 and 6, the two first urging portions 161 contact the upper surface of the pressing member 18 and urge the pressing member 18 downward. One of the two first urging portions 161 contacts a front portion of the upper surface of the pressing member 18, and the other contacts a rear portion of the upper surface of the pressing member 18. The pressing member 18 is long in the front-rear direction as described above. The two first urging portions 161 urge the peripheral edge of the connection portion 141 downward toward the actuator member 13 via the outer peripheral portion 182 of the pressing member 18.

As shown in FIGS. 5 and 6, the two second urging portions 162A urge the driver IC 15A upward toward the heat dissipation member 17 via the front folded portion 142. The two second urging portions 162B urge the driver IC 15B upward toward the heat dissipation member 17 via the rear folded portion 142.

The two second urging portions 162A are disposed for the one driver IC 15A, and the two second urging portions 162B are disposed for the one driver IC 15B. One of the two second urging portions 162A contacts a left portion of the driver IC 15A, and the other contacts a right portion of the driver IC 15A. One of the two second urging portions 162B contacts a left portion of the driver IC 15B, and the other contacts a right portion of the driver IC 15B. As shown in FIGS. 3 and 4, the driver ICs 15A and 15B are long in the left-right direction.

A sealant (sealing material) B is disposed along the inner peripheral edge of the frame 19. The sealant B may be, for example, a thermosetting fluorine-based potting material.

As shown in FIG. 5, the sealant B is disposed along the end of the connection portion 141, and blocks a space between the connection portion 141 and the actuator member 13 from the external space. When ink or moisture in the atmosphere enters the space, migration may occur between the plurality of individual electrodes 133. The sealant B suppresses the migration.

The volatile component in the ink reacts with the sealant B and changes the quality of the sealant B.

As described above, according to the present embodiment, the connection portion 141 is urged toward the actuator member 13 by the first urging portions 161 of the leaf spring 16 (see FIG. 5). Thus, the COF 14 is less likely to be separated from the actuator member 13.

The leaf spring 16 further includes the second urging portions 162A and 162B that urge the driver ICs 15A and 15B toward the heat dissipation member 17, in addition to the first urging portions 161 that urge the connection portion 141 toward the actuator member 13 (see FIGS. 5 to 7). Thus, the one leaf spring 16 provides both an effect of suppressing the COF 14 from being separated from the actuator member 13 and an effect of efficiently releasing heat that is generated in the driver ICs 15A and 15B to the heat dissipation member 17.

The two second urging portions 162A are disposed for the one driver IC 15A, and the two second urging portions 162B are disposed for the one driver IC 15B (see FIGS. 3, 4, and 7). Thus, the driver ICs 15A and 15B are urged toward the heat dissipation member 17 in a well-balanced manner.

One first urging portion 161 is disposed between the two second urging portions 162A, and the other first urging portion 161 is disposed between the two second urging portions 162B (refer to FIG. 7). Thus, the urging force of the first urging portions 161 and the urging force of the second urging portions 162A and 162B act in a well-balanced manner.

The first urging portions 161 urge the peripheral edge of the connection portion 141 toward the actuator member 13 (see FIG. 5). The peripheral edge of the connection portion 141 is a boundary between the connection portion 141 and the folded portions 142, and is a portion that tends to be separated from the actuator member 13. In the present embodiment, by urging that portion, the COF 14 is more reliably prevented from being separated from the actuator member 13.

The first urging portions 161 urge the peripheral edge of the connection portion 141 toward the actuator member 13 via the outer peripheral portion 182 of the pressing member 18 (see FIG. 5). In this case, the COF 14 is more reliably prevented from being separated from the actuator member 13 due to the pressing force from the outer peripheral portion 182 of the pressing member 18. Further, since the pressing member 18 has the recess 181 overlapping (facing) the contact region 13R, no load is applied to the bonding portion of the contacts 139 and 149 disposed in the contact region 13R, and deformation of the actuator member 13 is not hindered.

The two protrusions 183 of the pressing member 18 are inserted into the two through holes 163 of the leaf spring 16, and the adhesive A is disposed. The adhesive A closes the two through holes 163 and bonds the leaf spring 16 and the pressing member 18 to each other (see FIGS. 3 and 4). Thus, the leaf spring 16 is positioned in the left-right direction in which the two protrusions 183 are arranged.

Each of the two through holes 163 is larger in size than the two protrusions 183 in any direction perpendicular to the upper-lower direction (see FIGS. 3 and 4). Thus, when the leaf spring 16 and the pressing member 18 are assembled, a load is less likely to be applied to the periphery of the through holes 163 of the leaf spring 16. Further, the adhesive A is easily filled into the through holes 163, and the leaf spring 16 and the pressing member 18 are firmly bonded to each other.

The head 10 includes the adhesive tape 11 arranged between the pressing member 18 and the COF 14 for fixing the pressing member 18 and the COF 14 to each other (see FIG. 5). The adhesive tape 11 is arranged over the connection portion 141 and the folded portions 142 of the COF 14. The adhesive tape 11 has a function of maintaining the posture of the folded portions 142, but when the adhesive tape 11 reacts with the volatile component in the ink and the viscosity of the adhesive tape 11 decreases, the folded portions 142 hang down. When the folded portions 142 hang down, the radius of the boundary between the connection portion 141 and the folded portions 142 increases, and a force in a direction away from the actuator member 13 is applied to the vicinity of the boundary of the connection portion 141, and the contact 149 of the connection portion 141 may be separated from the contact 139 of the actuator member 13. However, in the present embodiment, the connection portion 141 is urged toward the actuator member 13 by the first urging portions 161 of the leaf spring 16, and thus the COF 14 is less likely to be separated from the actuator member 13.

The head 10 includes the sealant B which is arranged along the end of the connection portion 141 and which blocks the space between the connection portion 141 and the actuator member 13 from the external space (see FIG. 5). If the amount of the sealant B is not uniform between the front end and the rear end of the connection portion 141, the cure shrinkage speed of the sealant B is different, and a rotational moment is applied to the COF 14. Also, when the sealant B reacts with the volatile component in the ink and is altered, a rotational moment may be applied to the COF 14 in a similar manner. Thus, when the connection portion 141 is disposed obliquely with respect to the upper surface 13X of the actuator member 13, the contact 149 of the connection portion 141 may be separated from the contact 139 of the actuator member 13. However, in the present embodiment, the connection portion 141 is urged toward the actuator member 13 by the first urging portion 161 of the leaf spring 16, and thus the COF 14 is less likely to be separated from the actuator member 13.

The leaf spring 16 is employed as the urging member (see FIG. 7). Since the leaf spring 16 having a relatively simple configuration is adopted as the urging member, the number of components and the manufacturing cost of the head 10 as a whole are reduced.

While the present disclosure has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the present disclosure, and not limiting the present disclosure. Various changes may be made without departing from the spirit and scope of the disclosure. Thus, the disclosure is intended to embrace all known or later developed alternatives, modifications, variations, improvements, and/or substantial equivalents. Some specific examples of potential alternatives, modifications, or variations in the described disclosure are provided below.

The urging member is not limited to a leaf spring, and may be a compression spring, a torsion coil spring, and so on.

The urging member may not have the second urging portion.

The channel member is not limited to a serial type, and may be a line type.

The target object onto which liquid is ejected from the nozzle is not limited to a sheet of paper, and may be, for example, a cloth, a substrate, a plastic member, and so on.

The liquid ejected from the nozzle is not limited to liquid having a volatile

component. The liquid ejected from the nozzle is not limited to ink, and may be any liquid. For example, the liquid may be a treatment liquid that causes components in the ink to aggregate or precipitate.

The present disclosure is not limited to a printer, and is also applicable to a facsimile, a copier, a multifunction peripheral, and so on. The present disclosure is also applicable to a liquid ejection apparatus used for purposes other than image recording. For example, the liquid ejection apparatus may be a liquid ejection apparatus that forms a conductive pattern by ejecting a conductive liquid onto a substrate.

What is claimed is:

1. A liquid ejection head comprising:
a channel member having a liquid channel including a nozzle;
an actuator member disposed on an upper surface of the channel member, the actuator member having an upper surface on which a first contact is disposed, the actuator member being configured to cause the nozzle to eject liquid;
a wiring member including:
a connection portion disposed on the upper surface of the actuator member, the connection portion including a second contact electrically connected to the first contact; and
a folded portion folded upward from an end of the connection portion; and
a spring disposed above the connection portion, the spring including a first urging portion configured to urge the connection portion toward the actuator member.

2. The liquid ejection head according to claim 1, further comprising:
a driver circuit disposed above the spring; and
a heat sink disposed above the driver circuit,
wherein the spring further includes a second urging portion configured to urge the driver circuit toward the heat sink.

3. The liquid ejection head according to claim 2, wherein the second urging portion includes two second urging portions that are arranged to urge one driver circuit toward the heat sink.

4. The liquid ejection head according to claim 3, wherein the first urging portion is disposed between the two second urging portions.

5. The liquid ejection head according to claim 1, wherein the first urging portion is configured to urge a peripheral edge of the connection portion toward the actuator member.

6. The liquid ejection head according to claim 5, further comprising:
a pressing member disposed between the connection portion and the spring, the pressing member including:
a recess overlapping with a contact region in a perpendicular direction perpendicular to the upper surface of the actuator member, the contact region being a region in which the first contact is disposed on the upper surface of the actuator member; and
an outer peripheral portion surrounding the recess,
wherein the first urging portion is configured to urge a peripheral edge of the connection portion toward the actuator member via the outer peripheral portion.

7. The liquid ejection head according to claim 6, wherein the pressing member includes two protrusions protruding in a direction from the connection portion toward the spring in the perpendicular direction;
wherein the spring has two through holes through which respective ones of the two protrusions are inserted in the perpendicular direction; and
wherein the liquid ejection head further comprises adhesive closing the two through holes through which the respective ones of the two protrusions are inserted, the adhesive bonding the spring and the pressing member to each other.

8. The liquid ejection head according to claim 7, wherein each of the two through holes is larger in size than a corresponding one of the two protrusions in a direction perpendicular to the perpendicular direction.

9. The liquid ejection head according to claim 6, further comprising:
an adhesive tape disposed between the pressing member and the wiring member, the adhesive tape fixing the pressing member and the wiring member to each other, the adhesive tape being disposed over the connection portion and the folded portion,
wherein the liquid includes a volatile component that reduces viscosity of the adhesive tape.

10. The liquid ejection head according to claim 1, further comprising:
a sealant disposed along the end of the connection portion, the sealant blocking a space between the connection portion and the actuator member from an external space.

11. The liquid ejection head according to claim 1, wherein the spring is a leaf spring.

12. The liquid ejection head according to claim 11, further comprising:
a first driver circuit disposed above one end of the leaf spring in a first direction, the first direction being parallel to the upper surface of the actuator member;
a second driver circuit disposed above an other end of the leaf spring in the first direction; and
a heat sink disposed above the first driver circuit and the second driver circuit,
wherein the first urging portion is located at one end of the leaf spring in the first direction, the first urging portion being formed by bending the leaf spring toward the actuator member;
wherein the leaf spring further includes:
an other first urging portion located at an other end of the leaf spring in the first direction, the other first urging portion being formed by bending the leaf spring toward the actuator member;
two second urging portions located at the one end of the leaf spring in the first direction, the first urging portion being located between the two second urging portions in a second direction, the second direction being parallel to the upper surface of the actuator member and being perpendicular to the first direction, the two second urging portions being formed by bending the leaf spring toward the first driver circuit; and
two other second urging portions located at the other end of the leaf spring in the first direction, the other first urging portion being located between the two other second urging portions in the second direction, the two other second urging portions being formed by bending the leaf spring toward the second driver circuit.

13. A printer comprising:
a conveyor configured to convey a sheet; and
a liquid ejection head configured to eject liquid onto the sheet conveyed by the conveyor, the liquid ejection head comprising:
a channel member having a liquid channel including a nozzle;
an actuator member disposed on an upper surface of the channel member, the actuator member having an upper surface on which a first contact is disposed, the actuator member being configured to cause the nozzle to eject liquid;
a wiring member including:
a connection portion disposed on the upper surface of the actuator member, the connection portion including a second contact electrically connected to the first contact; and
a folded portion folded upward from an end of the connection portion; and
a spring disposed above the connection portion, the spring including a first urging portion configured to urge the connection portion toward the actuator member.
